(19) United States
(12) Patent Application Publication
(10) Pub. No.: US 2006/0025554 A1
(43) Pub. Date: Feb. 2, 2006

(54) Process for the production of high refractive index polysiloxane-based polymeric compositions for use in medical devices

(76) Inventors: Yu-Chin Lai, Pittsford, NY (US); Edmond T. Quinn, Rochester, NY (US)

Correspondence Address: Bausch & Lomb Incorporated, One Bausch & Lomb Place, Rochester, NY, 14604-2701, US

(21) Appl. No.: 11/225,348

(22) Filed: Sep. 13, 2005

Related U.S. Application Data
(62) Division of application No. 10/641,200, filed on Aug. 14, 2003.

(51) Int. Cl. C08G 77/04; C08G 77/20

(52) U.S. Cl. 528/32

(57) ABSTRACT

A process for producing polysiloxane prepolymers of improved homogeneity for use in the production of relatively high refractive index polymeric compositions is described herein. Polymeric compositions so produced are useful in the production of ophthalmic devices such as for example intraocular lenses and corneal inlays. The preferred polymeric compositions are produced through the copolymerization of one or more polysiloxane prepolymers with hydrosilane-containing polysiloxanes.

### CROSS REFERENCE

This application is a divisional of application Ser. No. 10/641,200. filed Aug. 14, 2003.

### FIELD OF THE INVENTION

The present invention relates to an improved process for the production of high refractive index polysiloxane-based polymeric compositions useful in the manufacture of biocompatible medical devices. More particularly, the present invention relates to an improved process for the production of polysiloxane-based polymeric compositions that eliminates difficulties experienced in preparing polysiloxane prepolymers to completion and difficulties experienced in the subsequent purification thereof.

### BACKGROUND OF THE INVENTION

Since the 1940's optical devices in the form of intraocular lens (IOL) implants have been utilized as replacements for diseased or damaged natural ocular lenses. In most cases, an intraocular lens is implanted within an eye at the time of surgically removing the diseased or damaged natural lens, such as for example, in the case of cataracts. For decades, the preferred material for fabricating such intraocular lens implants was poly(methyl methacrylate), which is a rigid, glassy polymer.

Softer, more flexible IOL implants have gained in popularity in more recent years due to their ability to be compressed, folded, rolled or otherwise deformed. Such softer IOL implants may be deformed prior to insertion thereof through an incision in the cornea of an eye. Following insertion of the IOL in an eye, the IOL returns to its original pre-deformed shape due to the memory characteristics of the soft material. Softer, more flexible IOL implants as just described may be implanted into an eye through an incision that is much smaller, i.e., less than 4.0 mm, than that necessary for more rigid IOLs, i.e., 5.5 to 7.0 mm. A larger incision is necessary for more rigid IOL implants because the lens must be inserted through an incision in the cornea slightly larger than the diameter of the inflexible IOL optic portion. Accordingly, more rigid IOL implants have become less popular in the market since larger incisions have been found to be associated with an increased incidence of postoperative complications, such as induced astigmatism.

With recent advances in small-incision cataract surgery, increased emphasis has been placed on developing soft, foldable materials suitable for use in artificial IOL implants. One such suitable class of soft, foldable materials is silicone elastomers fabricated through the polymerization of divinyl-end capped poly(dialkyl)-co-(diaromatic substituted) siloxane with polysiloxanes having multiple hydrosilane groups. This silicone elastomer producing polymerization reaction is achieved under thermal conditions using a platinum catalyst. A component added to the described siloxane and polysiloxanes prior to initiation of the polymerization reaction, is a reinforcing agent to enhance the mechanical properties of the silicone elastomer end product so fabricated. Examples of suitable reinforcing agents include a silica filler or an organic reinforcing resin such as polysiloxane with vinyl functional groups.

The prepolymer, divinyl-end capped poly(dialkyl)-co-(diaromatic substituted) siloxane used in the polymerization reaction described above, is prepared by reacting a 1,3-bisvinyl tetraalkyldisiloxane, a mixture of octamethylcyclo-tetrasiloxane and an aromatic group containing cyclosiloxane, especially octaphenylcyclo-tetrasiloxane. Using an amine or a potassium silanoate as a catalyst, the reaction used to prepare the noted prepolymer is carried out at 40-100° C. in neat or in an organic solvent. This polymerization reaction only reaches an equilibrium with cyclics, which are present in an amount typically between 20 to 30 percent of the total weight. Such cyclics are either those of the original components or those regenerated from the growing polymer, which then remain as side products. The resulting product was purified using a high temperature, high vacuum, thin film evaporator to remove solvent and volatile cyclics. Because of the poor solubility of the aromatic cyclics, incorporating a quantitative amount of the aromatic cyclics into the growing polymer molecule proved difficult. Likewise, due to high melting points, the aromatic cyclics have no vapor pressures and can not be removed using the thin film evaporator. As a result, in most cases, the aromatic cyclics remain as a contaminant in the final silicone elastomer product. The presence of aromatic cyclics as contaminants in the final silicone elastomer product creates the potential for defects and possible failures in products produced therefrom.

Because of the noted shortcomings in the quality of divinyl-end capped poly(dialkyl)-co-(diaromatic substituted) siloxane prepolymer using the described known process, there is a need to have an improved process for synthesizing the divinyl-end capped poly(dialkyl)-co-(diaromatic substituted) siloxane prepolymer.

### SUMMARY OF THE INVENTION

Soft, foldable, high refractive index, high elongation, polymeric compositions or silicone elastomers are prepared in accordance with the present invention by using a mixture of dialkyl siloxane cyclics and cyclics having both dialkylsiloxane and aromatic-containing siloxane units and 1,3-bisvinyl tetramethyldisiloxane. The improved production process of the present invention eliminates difficulties formerly encountered in preparing polysiloxane prepolymers to reach an equilibrium, as well as difficulties formerly encountered in the subsequent purification thereof. Following preparation of the polysiloxane prepolymers using the process of the present invention, the prepolymers are copolymerized with selected hydro-silane-containing polysiloxanes and other comonomers/components to form desirable polymeric compositions useful in the manufacture of biocompatible medical devices such as ophthalmic devices. Such desirable polymeric compositions are transparent, have a relatively high elongation of approximately 100 percent or greater, have a relatively high refractive index of at least approximately 1.42 and are particularly well suited for use in the manufacture of ophthalmic devices such as intraocular lens (IOL) implants, contact lenses, keratoprostheses, corneal rings, corneal inlays and the like. Medical devices fabricated from the polymeric compositions or silicone elastomers produced using polysiloxane prepolymers prepared in accordance with the present invention are of improved product quality and reliability due to the increased homogeneity of the subject polymeric compositions.

The process of the present invention is particularly useful for preparing divinyl-end capped poly(dialkyl)-co-(aromatic substituted) siloxane prepolymers having a structure generally represented by Formula 1 below: 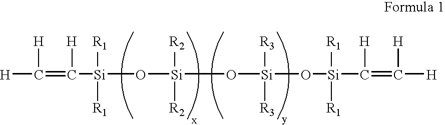
wherein the R₁ groups may be the same or different alkyl substituents or aromatic substituents; the R₂ groups may be the same or different alkyl substituents; the R₃ groups may be the same or different aromatic substituents or one of the two R₃ groups attached to the same silicon atom may be an alkyl substituent; and x and y may be the same or different natural numbers so that y/x+y is at least equal to 0.1 and each OSi(R₂)₂ and each OSi(R₃)₂ are independently and randomly distributed in the prepolymer molecule.

Accordingly, it is an object of the present invention to provide a process for the production of transparent, biocompatible polymeric compositions having desirable physical characteristics and relatively high refractive indices.

Another object of the present invention is to provide a process for the production of polymeric compositions having relatively high refractive indices and good clarity.

Another object of the present invention is to provide a process for the production of polymeric compositions suitable for use in the manufacture of ophthalmic devices.

Another object of the present invention is to provide a process for the production of polymeric compositions suitable for use in the manufacture of intraocular lens implants.

Still another object of the present invention is to provide a process for the production of polymeric compositions that are economical to produce.

These and other objectives and advantages of the present invention, some of which are specifically described and others that are not, will become apparent from the detailed description and claims that follow.

### DETAILED DESCRIPTION OF THE INVENTION

The present invention relates to a novel process for the production of divinyl-terminated poly(dialkyl)-co-(aromatic-substituted) siloxane prepolymers and the use of such prepolymers to produce biocompatible polymeric compositions having desirable physical properties and relatively high refractive indices for use in the manufacture of ophthalmic devices. The aromatic-substituted polysiloxane prepolymers of the present invention are represented generally by Formula 1 below: 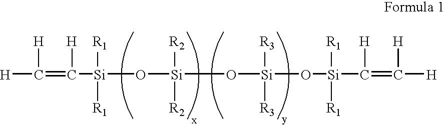
wherein the R₁ groups may be the same or different selected from the group consisting of C₁₋₁₀ alkyl substituents such as for example but not limited to methyl, propyl or octyl but preferably methyl and C₆₋₃₀ aromatic substituents such as for example but not limited to phenyl or naphthyl; the R₂ groups may be the same or different C₁₋₁₀ alkyl substituents such as for example but not limited to methyl, propyl, or octyl but preferably methyl; the R₃ groups may be the same or different C₆₋₃₀ aromatic substituents such as for example but not limited to phenyl or naphthyl, or one of the two R₃ groups attached to the same silicon atom may be a C₁₋₁₀ alkyl substituent such as for example but not limited to methyl, propyl or octyl; and x and y may be the same or different natural numbers so that y/x+y is at least equal to 0.1 and each OSi(R₂)₂ and OSi(R₃)₂ are independently and randomly distributed in the prepolymer molecule such that the prepolymer molecular weight is at least approximately 1000 and refractive index is at least 1.42.

The polysiloxane prepolymers of Formula 1 above are produced by using a mixture of dialkyl siloxane cyclics, cyclics having both dialkylsiloxane and aromatic-containing siloxane units and a vinyl siloxane such as for example, a 1,3-bisvinyl tetramethyldisiloxane. This polymerization reaction is generally represented in Reaction Scheme 1 below. 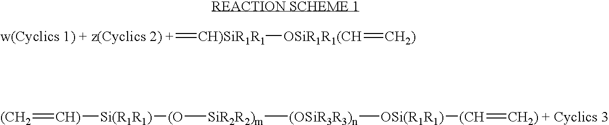
Here, Cyclics 1 is (R₂R₂SiO)ₚ; Cyclics 2 is (R₃R₃SiO)_{q}(R₂R₂SiO)ₜ; the R₁, R₂ and R₃ groups are defined the same as the R₁, R₂ and R₃ groups of Formula 1, respectively; m=pw+tz; n=qz; p, q, t, w, z, m and n are the same or different integers greater than 0, most preferably with p=3 or 4, q=1 or 2, t=2 or 3 and m=1 to 1000; the integer n depends on the nature of R₃ and the size of m, p, q and t after discounting units lost to cyclics; the integers w and z vary depending on the molecular weight and the refractive index of the prepolymer desired; and Cyclics 3 represents the mixture of cyclics side products from the insertion reaction process.

In the present process, as polymerization proceeds, the molecular weight grows until the reaction reaches an equilibrium. A polysiloxane prepolymer of Formula 1 with cyclics side products (Cyclics 3) in equilibrium therewith is thus produced. The final cyclics side product in equilibrium with the prepolymer, while complicated in nature in terms of structure, are all volatile enough to be removed from the prepolymer by techniques known to those skilled in the art. Such removal techniques include for example but are not limited to wipe-film evaporation, preparative size exclusion chromatography and super critical fluid extraction. As a result, the polysiloxane prepolymer so produced in accordance with the present invention is more homogeneous and thus is superior for use in the production of polymeric compositions for medical devices such as biocompatible ophthalmic devices.

Cyclics 2 represents mixed cyclics, and can be prepared by methods known by those skilled in the art. For example, mixed cyclics with 3 dimethylsiloxane units and 1 diphenylsiloxane unit can be prepared by reacting 1,1,3,3,5,5-hexamethyltrisiloxane (HMTS) with diphenyidichlorosilane in the presence of a catalyst.

Prepolymers of different refractive index can be prepared as depicted in Reaction Scheme 1 by adjusting the phenyl content in the mixed cyclics (Cyclics 2) and/or by varying the ratio thereof. Soft, foldable, relatively high refractive index of approximately 1.42 or greater, relatively high elongation of approximately 100 percent or greater, polymeric compositions are synthesized using one or more polysiloxane prepolymers produced through the process of the present invention. To produce the subject polymeric compositions, one or more polysiloxane prepolymers produced using the process of the present invention are copolymerized with a hydrosilane-containing polymer, and reinforcing components that are added to enhance the mechanical properties of the polymeric compositions so fabricated.

A hydro-silane containing polymer useful for copolymerization with the subject polysiloxane prepolymers, is generally represented by Formula 2 below. 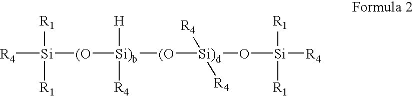
wherein the R₁ groups are defined the same as the R₁ groups of Formula 1 above; the R4 groups may be the same or different selected from the group consisting of hydrogen and C₁₋₁₀ alkyl substituents such as for example but not limited to methyl, propyl, or octyl but preferably methyl; and b and d may be the same or different natural numbers.

Suitable reinforcing components for use in the copolymerization of the polysiloxane prepolymer produced in accordance with the process of the present invention include but are not limited to a silicon filler or an organic resin such as for example a polysiloxane with multiple vinyl groups. However, regardless of which reinforcing agent is employed, the number of hydrosilane groups should be greater than or equal to the number of vinyl groups present in the final polymeric composition to be used in the manufacture of medical devices.

The polymeric compositions manufactured using polysiloxane prepolymers produced through the process of the present invention have refractive indices of approximately 1.42 or greater, relatively low glass transition temperatures of approximately 30 degrees Celsius or less and relatively high elongations of approximately 100 percent or greater. The polymeric compositions with the desirable physical properties described herein are particularly useful in the manufacture of ophthalmic devices such as but not limited to intraocular lenses (IOLs) and corneal inlays due to the increased homogeneity of the polysiloxane prepolymer.

IOLs having thin optic portions are critical in enabling a surgeon to minimize surgical incision size. Keeping the surgical incision size to a minimum reduces intraoperative trauma and postoperative complications. A thin IOL optic portion is also critical for accommodating certain anatomical locations in the eye such as the anterior chamber and the ciliary sulcus. IOLs may be placed in the anterior chamber for increasing visual acuity in both aphakic and phakic eyes and placed in the ciliary sulcus for increasing visual acuity in phakic eyes.

The polymeric compositions produced as described herein have the flexibility required to allow ophthalmic devices manufactured from the same to be folded or deformed for insertion into an eye through the smallest possible surgical incision, i.e., 3.5 mm or smaller. It is unexpected that the subject polymeric compositions described herein could possess the ideal physical properties disclosed herein. The ideal physical properties of the subject polymeric compositions are unexpected because high refractive index monomers or copolymers typically lead to polymers that have increased crystallinity and decreased clarity, which does not hold true in the case of the subject polymeric compositions.

One or more suitable ultraviolet light absorbers may optionally be used in the manufacture of the subject polymeric compositions. Such ultraviolet light absorbers include for example but are not limited to 2-[3′-tert-butyl-5′-(3″-dimethylvinylsilylproppoxy-2′-hydroxyphenyl]-5-methoxybenzotriazole or 2-(3′-allyl-2′-hydroxy-5′-methylphenyl)benztriazole.

The process of the present invention for making prepolymers is particularly useful in the manufacture of high refractive index silicone IOLs free of non-dissolvable particles. The key feature of this process is the preparation of cyclics containing no more than 25 percent phenyl groups and the cyclic products having a refractive index of at least 1.46. Polymeric compositions made from such polysiloxane prepolymers produced in accordance with the process of the present invention, having refractive indices of approximately 1.42 or greater and elongation of 100 percent or greater, are described in still greater detail in the examples that follow.

### EXAMPLE 1

### Preparation of methylphenyl siloxane-containing cyclics: 1-phenyl,1,3,3,5,5,7,7-heptamethylcyclotetrasiloxane

A dry, clean 3-neck, 500-mL round bottom flask equipped with reflux condenser and nitrogen blanket, was charged with 51.66 grams (0.232 mole) of 1,1,3,3,5,5-hexamethyl cyclotrisiloxane and 44.09 grams (0.231 mole) of dichloromethylphenylsilane. The contents were heated at 60° C. to melt. Then hexamethylphosphoric triamide (52 microliter) was added and the reaction mixture was allowed to stir overnight. The mixture was then slowly added to a stirring mixture of 32 grams of water and diethyl ether. The mixture was then placed in a separatory funnel. The organic layer separated and was washed two times with 5% sodium bicarbonate and 5 times with water until the pH was 7.0. The ether solution was then dried with magnesium sulfate. The solvent was then stripped to give product with over 90% purity. The refractive index was higher than 1.455.

### EXAMPLE 2

### Preparation of diphenyl-siloxane containing cyclics: 1,1-diphenyl,3,3,5,5,7,7-hexamethylcyclotetrasiloxane

A dry, clean 3-neck, 500-mL round bottom flask equipped with reflux condenser and nitrogen blanket, is charged with 51.66 grams (0.232 mole) of 1,1,3,3,5,5-hexamethyl cyclotrisiloxane and 58.44 grams (0.231 mole) of dichloromethylphenylsilane. The contents are heated at 60° C. to melt. Then hexamethylphosphoric triamide (52 microliter) is added and the reaction mixture is allowed to stir overnight. The mixture is then slowly added to a stirring mixture of 32 grams of water and diethyl ether. The mixture is then placed in a separatory funnel. The organic layer to be separated is washed two times with 5% sodium bicarbonate and 5 times with water until the pH is 7.0. The ether solution is then dried with magnesium sulfate. The solvent is then stripped to give product with over 90% purity.

### EXAMPLE 3

### Synthesis of a α ω-bis-vinylpolydimethylsiloxane of molecular weight 6,000

A dry, clean 3-neck, 500-mL round bottom flask equipped with reflux condenser and nitrogen blanket, was charged with 87.46 grams (0.295 mole) of 1,1,3,3,5,5,7,7-octamethyl cyclotetrasiloxane, 2.78 g (0.0149 mole) of 1,3-divinytetramethyldisiloxane and 133 microliter of triflic acid (0.25 weight %). The contents were stirred under nitrogen blanket overnight. The contents were then dissolved in ethyl ether and washed with 0.05N of NaOH in water until the solution reached pH 7.0. The ether solution was then dried with magnesium sulfate. The solvent was then stripped under reduced pressure to give final product. Molecular weight of the prepolymer, (by Size Exclusion Chromatography, using polystyrene standards): Mn=7360, Mw=13200, with 25 percent cyclics.

### EXAMPLE 4

### Preparation of divinyl-terminated polysiloxane with Refractive Index at Least 1.45

A dry, clean 3-neck, 500-mL round bottom flask equipped with mechanical stirrer, reflux condenser and nitrogen blanket, was charged with 68.12 grams of 1-phenyl-1,3,3,5,5,7,7-heptamethyl cyclotetrasiloxane from Example 1, 5.40 g (0.0149 mole) of α ω-bis-vinylpolydimethylsiloxane from example 3, 14.87 grams of 1,1,3,3,5,5,7,7-octamethyl cyclotetrasiloxane, 9.05 grams of 1,3,5,7-tetramethyl-1,3,5,7-tetraphenyl cyclotetrasiloxane, and 0.0139 gram of potassium trimethylsilanoate. The contents were heated with mechanical stirring until 150-160° C. was reached. It was then purged with nitrogen for 1 to 2 minutes. The contents were then stirred at 160° C. The viscosity started to increase rapidly. The reaction was terminated after heating overnight. The prepolymer had Mn of 98100, Mw=193,100 (by Size Exclusion Chromatography). Refractive index was measured as 1.457.

### EXAMPLE 5

### Comparison of divinyl-end Capped polydimethyl-co-diphenylsiloxane made by Different Processes

A product purchased from Gelest, Inc. with a refractive index of 1.465 and a 15-17% diphenylsiloxane content fabricated from diphenylsiloxane cyclics (catalog #PDV1641), was compared to the product of Example 4 under a microscope (30×). It was found that the product produced from diphenylsiloxane cyclics had a lot irregular-shaped crystallites and strings of droplet-like defects whereas the product of Example 4 did not.

### EXAMPLE 6

### Preparation of divinyl-terminated polysiloxane with Refractive Index at Least 1.49

A dry, clean 3-neck, 500-mL round bottom flask equipped with mechanical stirrer, reflux condenser and nitrogen blanket, is charged with 44.1 grams (0.105 mole) of 1,1-diphenyl-3,3,5,5,7,7-hexamethyl cyclotetrasiloxane, 4.9 g (0.7 mmole) of α ω-bis-vinylpolydimethylsiloxane of Mn 7,000, and 0.011 gram of potassium trimethylsilanoate. The contents are heated with mechanical stirring until 150-160° C. is reached. The contents are then purged with nitrogen for 1 to 2 minutes and then stirred at 160° C. under nitrogen blanket again. The viscosity of the contents starts to increase rapidly. The reaction is terminated after heating the same temperature overnight. The prepolymer has an expected Mn of 70,000. Refractive index is higher than 1.49.

### EXAMPLE 7

### Preparation of hydroxybutyl-terminated copolymer of dimethylsiloxane and diphenylsiloxane (with 25 mole % phenyl content)

1,3-bis(hydroxybutyl)tetramethyl disiloxane (34.098 g, 0.1226 mole), dimethyldimethoxysilane (501.4 g, 4.046 moles) and diphenyldimethoxysilane (339.8 g, 1.349 moles) were added in a one-liter round bottom flask. Water (97.1 g) and concentrated hydrochloric acid (8 mL) were then slowly added to the flask. The contents of the flask were refluxed for one hour. Methanol (320 mL) was distilled from the contents. Water (500 mL) and concentrated hydrochloric acid (130 mL) were added to the flask. The contents of the flask were refluxed for one hour. The contents of the flask were then poured into a separatory funnel. The silicone layer was separated, diluted with 500 mL ether and washed once with 250 mL water, twice with 250 mL 5-percent sodium bicarbonate aqueous solution and twice with 250 mL water. The final organic layer was dried with magnesium sulfate, and then vacuum stripped at 80 degrees Celsius (0.1 mm Hg) to give the crude product. The crude product was transferred to a clear glass vial. After standing for over two weeks. White crystals were found against the vial wall. This indicated that cyclics rich in diphenylsiloxane content did form solid crystals (particles). While this particular example is not a divinyl—terminated polydimethylssiloxane-co-diphenylsiloxane, it did provide the same phenomenon which could be overcome by the method of the present invention.

Medical devices produced using polymeric compositions or silicone elastomers produced using the process of the present invention may be manufactured in accordance with methods known to those skilled in the art of the specific ophthalmic device being produced. For example, if an intraocular lens is to be produced, the same may be manufactured by methods known to those skilled in the art of intraocular lens production.

Ophthalmic devices such as but not limited to IOLs and corneal inlays manufactured using polymeric compositions produced using the process of the present invention can be of any design capable of being rolled or folded for implantation through a relatively small surgical incision, i.e., 3.5 mm or less. For example, intraocular implants such as IOLs comprise an optic portion and one or more haptic portions. The optic portion reflects light onto the retina and the permanently attached haptic portions hold the optic portion in proper alignment within an eye following implantation. The haptic portions may be integrally formed with the optic portion in a one-piece design or attached by staking, adhesives or other methods known to those skilled in the art in a multipiece design.

The subject ophthalmic devices, such as for example IOLs, may be manufactured to have an optic portion and haptic portions made of the same or differing materials. Preferably, in accordance with the present invention, both the optic portion and the haptic portions of the IOLs are made of the same polymeric composition produced using the process of the present invention. Alternatively however, the IOL optic portion and haptic portions may be manufactured from different materials and/or different formulations of polymeric compositions produced using the process of the present invention, such as described in detail in U.S. Pat. Nos. 5, 217,491 and 5,326,506, each incorporated herein in their entirety by reference. Once the material(s) are selected, the same may be cast in molds of the desired shape, cured and removed from the molds. After such molding, the IOLs are then cleaned, polished, packaged and sterilized by customary methods known to those skilled in the art. Alternatively, rather than molding, the IOLs may be manufactured by casting said polymeric composition in the form of a rod; lathing or machining said rod into disks; and lathing or machining said disks into an ophthalmic device prior to cleaning, polishing, packaging and sterilizing the same.

In addition to IOLs, polymeric compositions produced using the process of the present invention are also suitable for use in the production of other ophthalmic devices such as contact lenses, keratoprostheses, capsular bag extension rings, corneal inlays, corneal rings and like devices.

Ophthalmic devices manufactured using polymeric compositions produced using the process of the present invention are used as customary in the field of ophthalmology. For example, in a surgical cataract procedure, an incision is placed in the cornea of an eye. Through the corneal incision the cataractous natural lens of the eye is removed (aphakic application) and an IOL is inserted into the anterior chamber, posterior chamber or lens capsule of the eye prior to closing the incision. However, the subject ophthalmic devices may likewise be used in accordance with other surgical procedures known to those skilled in the field of ophthalmology.

While there is shown and described herein a process for producing polysiloxane prepolymers, and polymeric compositions and ophthalmic devices made from the subject polysiloxane prepolymers, it will be manifest to those skilled in the art that various modifications may be made without departing from the spirit and scope of the underlying inventive concept and that the same is not limited to particular processes and structures herein shown and described except insofar as indicated by the scope of the appended claims.

We claim:

1-13. (canceled)

14. A process for producing a polysiloxane prepolymer, the process comprising:
polymerizing dialkyl siloxane cyclics, cyclics having both dialkylsiloxane and aromatic-containing siloxane units, and a vinyl siloxane;
wherein the prepolymer has a formula of 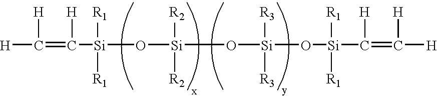
wherein the R₁ groups may be the same or different selected from the group consisting of C₁₋₁₀ alkyl substituents and C₆₋₃₀ aromatic substituents; the R₂ groups may be the same or different C₁₋₁₀ alkyl substituents; the R₃ groups may be the same or different C₆₋₃₀ aromatic substituents or one of the two R₃ groups attached to the same silicon atom may be a C₁₋₁₀ alkyl substituent; and x and y may be the same or different natural numbers with y/x+y at least equal to 0.1.

15. A process for minimizing aromatic cyclic contaminants in a silicone elastomer comprising:
polymerizing dialkyl siloxane cyclics, cyclics having both dialkylsiloxane and aromatic-containing siloxane units, and a vinyl siloxane.

16. A process for producing a homogeneous polysiloxane prepolymer comprising:
polymerizing dialkyl siloxane cyclics, cyclics having both dialkylsiloxane and aromatic-containing siloxane units, and a vinyl siloxane.

17. A process for producing a high refractive index polysiloxane prepolymer without increasing crystallinity and decreasing clarity comprising:
polymerizing dialkyl siloxane cyclics, cyclics having both dialkylsiloxane and aromatic-containing siloxane units, and a vinyl siloxane.

18. A process for producing a polysiloxane prepolymer having a refractive index of at least 1.42 comprising:
polymerizing dialkyl siloxane cyclics, cyclics having both dialkylsiloxane and aromatic-containing siloxane units, and a vinyl siloxane.

19. The process of claim 14, 15, 16, 17 or 18 wherein said dialkyl siloxane cyclics comprise:
(R₂R₂SiO)ₚ
wherein the R₂ groups may be the same or different C₁₋₆ alkyl substituents; and p is an integer greater than 0.

20. The process of claim 14, 15, 16, 17 or 18 wherein said cyclics having both dialkylsiloxane and aromatic-containing siloxane units comprise:
(R₃R₃SiO)_{q}(R₂R₂SiO)ₜ
wherein the R₂ groups may be the same or different C₁₋₆ alkyl substituents; the R₃ groups may be the same or different C₆₋₃₀ aromatic substituents, or one of the two R₃ groups attached to the same silicon atom may be a C₁₋₁₀ alkyl substituent; and q and t are the same or different integers greater than 0.

21. The process of claim 14, 15, 16, 17 or 18 wherein said vinyl siloxane comprises:
(CH₂═CH)Si(R₁R₁)−OSi(R₁R₁)(CH═CH₂)
wherein the R₁ groups may be the same or different selected from the group consisting of C₁₋₆ alkyl substituents and C₆₋₃₀ aromatic substituents.

22-32. (canceled)
